(19) United States
(12) Patent Application Publication
(10) Pub. No.: US 2016/0225274 A1
(43) Pub. Date: Aug. 4, 2016

(54) SYSTEM AND METHOD FOR PROVIDING ADAPTIVE TEACHING EXERCISES AND QUIZZES

(71) Applicant: Zyante, Inc., Los Gatos, CA (US)

(72) Inventors: Frank Vahid, Los Gatos, CA (US); Alex Edgcomb, Los Gatos, CA (US); Sarah Strawn, Los Gatos, CA (US)

(21) Appl. No.: 15/010,964

(22) Filed: Jan. 29, 2016

Related U.S. Application Data
(60) Provisional application No. 62/109,541, filed on Jan. 29, 2015.

(51) Int. Cl. G09B 7/02

(52) U.S. Cl. CPC G09B 7/02

(57) ABSTRACT

Systems and methods are disclosed for providing adaptive learning activities, such as exercises, quizzes, tests, examination, learning assessment tools, and other learning activities. A first aspect involves the system providing a progressive learning activity, where a question associated with a first step is presented to a user. If the user responds to the question incorrectly, the system presents the user another question associated with the first step. If the user responds correctly, the system presents the user another question associated with a second step. The questions get progressively more difficult as the user completes steps. A second aspect involves the system presenting a list of topics for review by the user based on responding to a single question or multiple questions. A third aspect involves the system generating a quiz based on one or more parameters selected by a user or based on a learning progress indicator of the user.

### CROSS REFERENCE TO RELATED APPLICATION

This application claims the benefit of the filing date of U.S. Provisional Patent Application, Ser. No. 62/109,541, filed on Jan. 29, 2015, entitled “Adaptive Exercise and Quizzing System,” which is incorporated herein by reference.

### FIELD

This disclosure relates generally to generally learning systems, and in particular, to a system and method for providing adaptive teaching exercises and quizzes.

### BACKGROUND

Generally, subject matter taught to students at a learning institution, such as an elementary school, high school, college, or university, is usually organized and presented in a static manner. That is, how the subject matter is presented to the students do not take account the learning progress of an individual student.

For instance, students in a classroom are taught the same subject throughout the term of the class without consideration of the individual student's ability to learn the subject matter. As a result, some weaker students are presented subject matter that they are not yet capable of understanding. On the other hand, some stronger students are presented subject matter that they already fully understand, and may get bored with the teaching of the subject matter.

Thus, there is a need to structure learning activities that take into account the learning progress of the individual students.

### SUMMARY

An aspect of the disclosure relates to a user device, comprising a user interface, and a processor configured to: instruct the user interface to display a first screen including a first question assigned to a first step of a learning activity, wherein the first screen includes a first input object configured to receive a first response to the first question from a user; and instruct the user interface to display a second screen including a second question assigned to the first step of the learning activity in response to an incorrect response received via the first input object; or instruct the user interface to display a third screen including an indication that the learning activity has been completed by the user in response to a correct response received via the first input object and no other step of the learning activity is required to be completed by the user to complete the learning activity; or instruct the user interface to display a fourth screen including a third question assigned to a second step of the learning activity in response to a correct response received via the first input object and the second step is required to be completed by the user to complete the learning activity.

Another aspect of the disclosure relates to a user device, comprising a user interface, and a processor configured to: instruct the user interface to display a first screen including a question of a learning activity, wherein the first screen includes an input object configured to receive response to the question from a user; and instruct the user interface to display a second screen including one or more identifiers to one or more topics recommended for reviewing by the user based on the response to the question received from the user via the input object.

Another aspect of the disclosure relates to a user device, comprising a user interface, and a processor configured to: instruct the user interface to display a set of screens including a set of questions of a learning activity, wherein the set of screens include a set of input objects configured to receive a set of responses to the set of question from a user, respectively; and instruct the user interface to display a second screen including one or more identifiers to one or more topics recommended for reviewing by the user based on at least some of the responses of the set.

Another aspect of the disclosure relates to a user device, comprising a user interface, and a processor configured to: instruct the user interface to display a first screen including one or more input objects to receive one or more parameters from a user, the one or more parameters controlling a selection or generation of a set of questions; and instruct the user interface to display a set of screens including the set of questions selected or generated based on the one or more parameters, respectively, wherein the set of screens include a set of input objects to receive responses to the set of questions from the user, respectively.

Another aspect of the disclosure relates to a user device, comprising a user interface, and a processor configured to: instruct the user interface to display a set of screens including the set of questions based on a learning progress metric associated with a user, wherein the set of screens includes a set of input objects to receive responses to the set of questions from the user, respectively.

Other aspects, advantages and novel features of the present disclosure will become apparent from the following detailed description when considered in conjunction with the accompanying drawings.

### BRIEF DESCRIPTION OF THE DRAWINGS

FIG. 1 illustrates a block diagram of an exemplary communication system in accordance with an aspect of the disclosure.

FIG. 2 illustrates a block diagram of an exemplary server in accordance with another aspect of the disclosure.

FIG. 3 illustrates a block diagram of an exemplary user device in accordance with another aspect of the disclosure.

FIG. 4 illustrates a flow diagram of an exemplary method of providing a learning activity in accordance with another aspect of the disclosure.

FIGS. 5A-1 to 5A-3 illustrate a first set of exemplary screens of questions related to a first step of a learning activity in accordance with another aspect of the disclosure.

FIGS. 5B-1 to 5B-3 illustrate a second set of exemplary screens of questions related to a second step of the learning activity in accordance with another aspect of the disclosure.

FIGS. 5C-1 to 5C-3 illustrate a third set of exemplary screens of questions related to a third step of the learning activity in accordance with another aspect of the disclosure.

FIG. 6 illustrates a flow diagram of an exemplary method of generating questions based on first, second, and third sets of constraints related respectively to first, second, and third steps of a learning activity in accordance with another aspect of the disclosure.

FIGS. 7A-7C illustrate exemplary screens after submission of respectively correct, incorrect, and another incorrect responses to a question of a learning activity in accordance with another aspect of the disclosure.

FIG. 8A illustrates a flow diagram of an exemplary method of providing a learning activity that presents one or more topics based on a response to a question in accordance with another aspect of the disclosure.

FIG. 8B illustrates a flow diagram of an exemplary method of providing a learning activity that presents one or more topics based on a set of responses to a set of questions in accordance with another aspect of the disclosure.

FIG. 9A illustrates an exemplary screen after submission of an incorrect response to a question of a learning activity in accordance with another aspect of the disclosure.

FIG. 9B illustrates an exemplary screen of a presentation or content of a topic accessed by a user by activating a topic hyperlink related to the topics in the screen depicted in FIG. 9A in accordance with another aspect of the disclosure.

FIG. 9C illustrates an exemplary screen after activating a return hyperlink (e.g., “Return to Quiz”) in the screen depicted in FIG. 9B in accordance with another aspect of the disclosure.

FIG. 9D illustrates an exemplary screen after completion of a learning activity (e.g., exercise or quiz) in accordance with another aspect of the disclosure.

FIG. 10 illustrates a flow diagram of an exemplary method of generating a learning activity (e.g., quiz) based on one or more parameters provided by a user in accordance with another aspect of the disclosure.

FIG. 11 illustrates an exemplary screen including an exemplary quiz generator in accordance with another aspect of the disclosure.

FIGS. 12A-1 to 12A-3 illustrate a first set of screens of exemplary questions related to a first difficulty level of a learning activity in accordance with another aspect of the disclosure.

FIGS. 12B-1 to 12B-3 illustrate a second set of screens of exemplary questions related to a second difficulty level of the learning activity in accordance with another aspect of the disclosure.

FIGS. 12C-1 to 12C-3 illustrate a third set of screens of exemplary questions related to a third difficulty level of the learning activity in accordance with another aspect of the disclosure.

FIG. 13 illustrates a flow diagram of an exemplary method of generating questions based on first, second, and third sets of constraints related respectively to first, second, and third difficulty levels of a learning activity in accordance with another aspect of the disclosure.

FIG. 14 illustrates a flow diagram of another exemplary method of generating a learning activity (e.g., quiz) based on a learning progress metric of a user in accordance with another aspect of the disclosure.

### DETAILED DESCRIPTION OF THE EXEMPLARY EMBODIMENTS

### System Environment

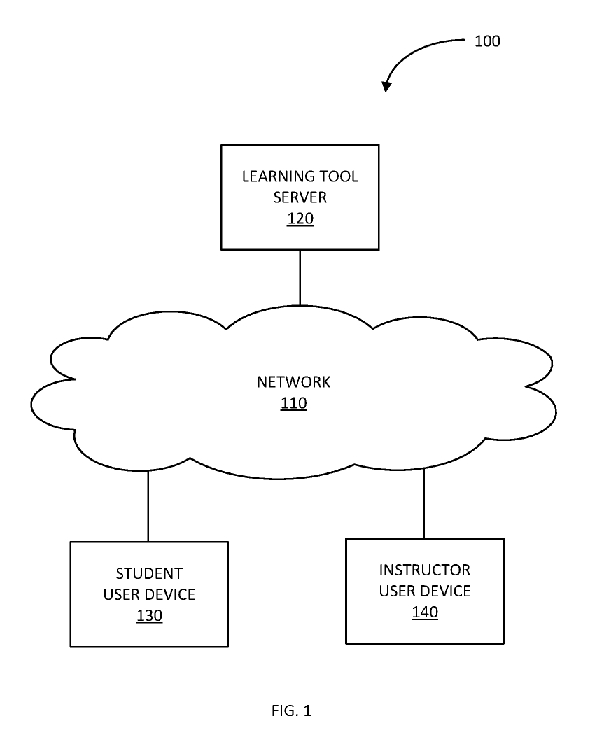

FIG. 1 illustrates a block diagram of an exemplary communication system 100 in accordance with an aspect of the disclosure. The communication system 100 includes a learning tool server 120, a student user device 130, an instructor user device 140, all of which are coupled to a network 110.

The network 110 may be any network through which data and control signals (instructions) are communicated between the learning tool server 120, the student user device 130, and the instructor user device 140. Examples of the network 110 include a wide area network (WAN), such as the Internet, a local area network (LAN), a cellular telephone network, any combination of one or more of the aforementioned, or other type of networks.

As discussed in more detail herein, the learning tool server 120 is configured to send instructions (e.g., control signals) and data to the student user device 130 and receive data from the student user device 130 and the instructor user device 140 to provide a learning activity for a user of the student user device 130. A learning activity may include an exercise, quiz, test, examination, a learning assessment tool, or other tool that presents the user of the student user device 130, a set of questions and receives a corresponding set of responses from the user. As discussed in more detail herein, the learning activity may include many attributes that enhances the learning experience and assessment of the user of the student user device 130. The learning tool server 120 may instruct or control the student user device 130 in providing a learning activity for the user by sending instructions in the form of scripts or software, such as JavaScript, HTML files, XML files, applications, or other forms of browser or device control signals. The instructions, such as an application or software, may be sent to the student user device 130 via a proxy server, such as a server that includes applications, software, and updates for downloading by the student user device 130.

Although not shown in FIG. 1, a database may be associated with the learning tool server 120 for storing and accessing data associated with a learning activity implemented on the student user device 130. For instance, the database may include premade questions associated with the learning activity, question generating script or software program, user data objects for keeping track of data related to the user of the student user device 130 and the user of the instructor user device 140.

For example, a user data object for the user of the student user device 130 may include information related to learning activities completed or being completed (in-progress) by the user, such as information from which a learning performance indicator or metric for the user may be derived, information related to learning topics the user has reviewed or should review, information related to parameters submitted by the user in creating his/her own quizzes, and/or other information related to learning activities as described herein. A user data object for the user of the instructor user device 140 may include information identifying users (e.g., students) for which the user-instructor may control or adjust the learning activities, and the degree of the control or adjustment of the learning activities, as described in more detail further herein.

As discussed in more detail herein, the student user device 130 is an example of a device (e.g., desktop computer, laptop computer, smart phone, tablet device, or other type of computing device) used by a user, such as a student, desiring to communicate with the learning tool server 120 so that one or more learning activities may be provided to the user-student via the student user device 140. Similarly, the instructor user device 140 is an example of a device (e.g., desktop computer, laptop computer, smart phone, tablet device, or other type of computing device) used by a user, such as an instructor or learning institution administrator, desiring to communicate with the learning tool server 120 to control or adjust learning activities provided to the user of the student user device 130.

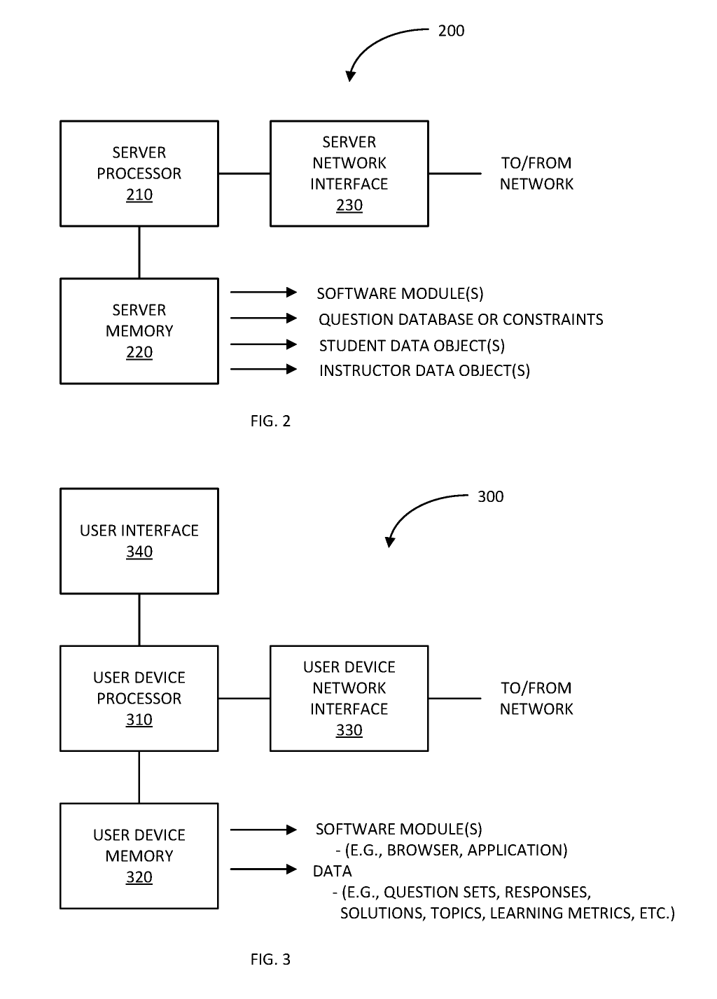

FIG. 2 illustrates a block diagram of an exemplary learning tool server 200 in accordance with another aspect of the disclosure. The learning tool server 200 may be an exemplary detailed implementation of the learning tool server 120 previously discussed.

In particular, the learning tool server 200 comprises a server processor 210, a server memory 220, and a server network interface 230. As discussed in more detail herein, the server processor 210 performs the various operations to provide control instructions and data to and receive data from the student user device 130 so that the student user device 130 provides a learning activity for the user. Additionally, the server processor 210 performs the various operations to receive data from the instructor user device 140 in order to control or adjust the learning activity provided by the student user device 130.

The server memory 220 stores one or more software modules for controlling the operations of the server processor 210 as discussed herein. Additionally, the server memory 220 stores information associated with learning activities, students (e.g., student data objects), instructors (e.g., instructor data objects), and other information to effectuate one or more learning activities provided by the student user device 130. The server memory 220 may be any type of device for storing information, such as random access memory (RAM), non-volatile memory, solid-state drives (SSDs), hard magnetic disk drives, any combinations of the aforementioned devices, as well as others. At least some of the server memory 220 may be implemented separate from the learning tool server 200, such as the case of a database that is coupled to the network 110, and accessible by the processor 210 via the server network interface 230.

The server network interface 230 facilitates data and control signal (instruction) communications between the learning tool server 200 and other devices on the network 110, such as the student user device 130 and the instructor user device 140. The server network interface 230 may facilitate wired data communications, wireless data communications, or both wired and wireless data communications.

FIG. 3 illustrates a block diagram of an exemplary user device 300 in accordance with another aspect of the disclosure. The user device 300 may be an exemplary detailed implementation of the student user device 130 and/or the instructor user device 140. In particular, the user device 300 comprises a user device processor 310, a user device memory 320, a user device network interface 330, and a user interface 340.

As discussed in more detail herein, in the case of a student user device, the user device processor 310 performs the various operations to communicate with the learning tool server 120 to provide the various learning activities and attributes as described herein. In the case of an instructor user device, the user device processor 310 performs the various operations to communicate with the learning tool server 120 to control or adjust learning activities provided by the student user device 130 as described herein. The user device processor 310 may be any type of processor, microprocessor, microcontroller, etc.

The user device memory 320 stores one or more software modules for controlling the operations of the user device processor 310 previously discussed. Such software module(s) include a browser, an application (e.g., smart phone application), software executable by computers, etc. Additionally, the user device memory 320 stores data for effectuating the learning activities described herein, such as question sets, responses to questions, suggested topics, learning metrics, and other information. The user device memory 320 may be any type of device for storing information, such as random access memory (RAM), non-volatile memory, solid-state drives (SSDs), hard magnetic disk drives, and others.

The user device network interface 330 facilitates data communication between the user device 300 and other devices on the network 110, such as the learning tool server 120. The user device network interface 330 may facilitate wired data communications, wireless data communications, or both wired and wireless data communications. It shall be understood that the user device need not be coupled to the server 120 or 200 and/or need not have connectivity to the network 100 to implement the operations described herein. This may be the case where the user device may be loaded with an application or software that may perform all operations described herein.

The user interface 340 may be any input and output device that a user uses to provide data to and receive data from the user device processor 310. Examples of input devices include keyboards (hard or soft), pointing devices (e.g., mouse or track ball), microphone, touch-sensitive displays, and others. Examples of output devices include displays, speakers, tactile devices, etc. In this context, the user interface 340 serving as a display provides screens for implementing learning activities as described herein. It shall be understood that the user interface 340, acting as a display, may display one or more screens simultaneously, such as a plurality of screens inside a window, with screens displayed side-by-side, or integrated into a single scene. Also, in this context, the user interface 340 serving as an input device, such as a keyboard and/or a pointing device, allows a user to provide data requested in accordance with the learning activities as described herein.

### Progressive Learning Activity

Computer learning activities provide the possibility of adapting to the student. A recent form of adaptation approach (ALEKS, Knewton) presents each student unique topics based on their performance. For example, if a student does poorly on topic A, the student may be presented with topics B and C. If the student does well on topic A, the student is presented with topic D.

However, a structured arrangement of the material, as in a traditional textbook, is important to help the student mentally organize the topic matter. A structured arrangement also supports group work, so that students can collaborate as they study the same topics. A structured arrangement also enables teachers to synchronize class time subject matter with topics being studied by students on their computers.

Thus, an adaptive approach is needed that has a structured arrangement of material, yet supports some adaptivity to the student.

A “progression activity” (also known herein as a “learning activity”) provides a beneficial adaptive approach. A progression activity has multiple steps that are shown to the student, such as steps 1, 2, and 3 as described herein. Each step, a user device displays a question with the same or increased difficulty compared to a question displayed in a previous step. If answered correctly, the current step is completed. Else, the user device displays a new question of similar difficulty. Explanations of the solutions (correct answer) are also displayed by the user device.

A progression (or learning) activity is adaptive by requiring the user to demonstrate mastery of a particular problem difficulty before moving on to a harder problem on that topic. Yet, a progression activity can be placed within a structured arrangement of material; thus striking a beneficial balance between structure and adaptivity.

In summary, a learning activity may include: two or more ordered steps of the same or increasing difficulty; a representation of each step is displayed to the student (numbers, blocks, etc.); and, an indication of whether the step has been completed. Where in each step: a question is shown to a user (e.g., a student); accepts an answer from the student; provides an explanation of the correct solution; indicates whether the user was right or wrong; if wrong, generates another question of similar difficulty; and, if right indicates that the step is completed, and proceeds to the next step if one exists.

In some aspects, some number of points is earned for completing a step. In other aspects, the user may repeat the one or more steps of the learning activity, but retains step points already earned. In other aspects, the learning activity is indicated as being completed when all required steps are marked as being completed. In other aspects, a user may complete only the last step, regardless of the completion status of prior steps, and the learning activity is indicated as being complete.

In some aspects, the system starts a user at a first step, and proceeds to the next step when the first step has been completed by the user. In other aspects, the system allows a user to select the first step of a learning activity. In other aspects, the system starts a user at a step based on user's performance of one or more prior activities (e.g., a learning progress metric). In other aspects, the system may require a user to complete one or more steps above a certain indicated step.

In some aspects, an incorrect answer submitted by a user results in a visual depiction of the wrong parts of the answer. In other aspects, an incorrect answer to a question submitted by a user results in a correct answer being shown, with visual display of the differences between the right and wrong answers. In other aspects, each question may be selected from a database of questions or may be automatically generated based on one or more constraints. The automatically-generated question may be automatically graded as correct or incorrect.

The following provides description of flowcharts and display screens for exemplifying the aforementioned concepts related to an adaptive exercise or quizzing system.

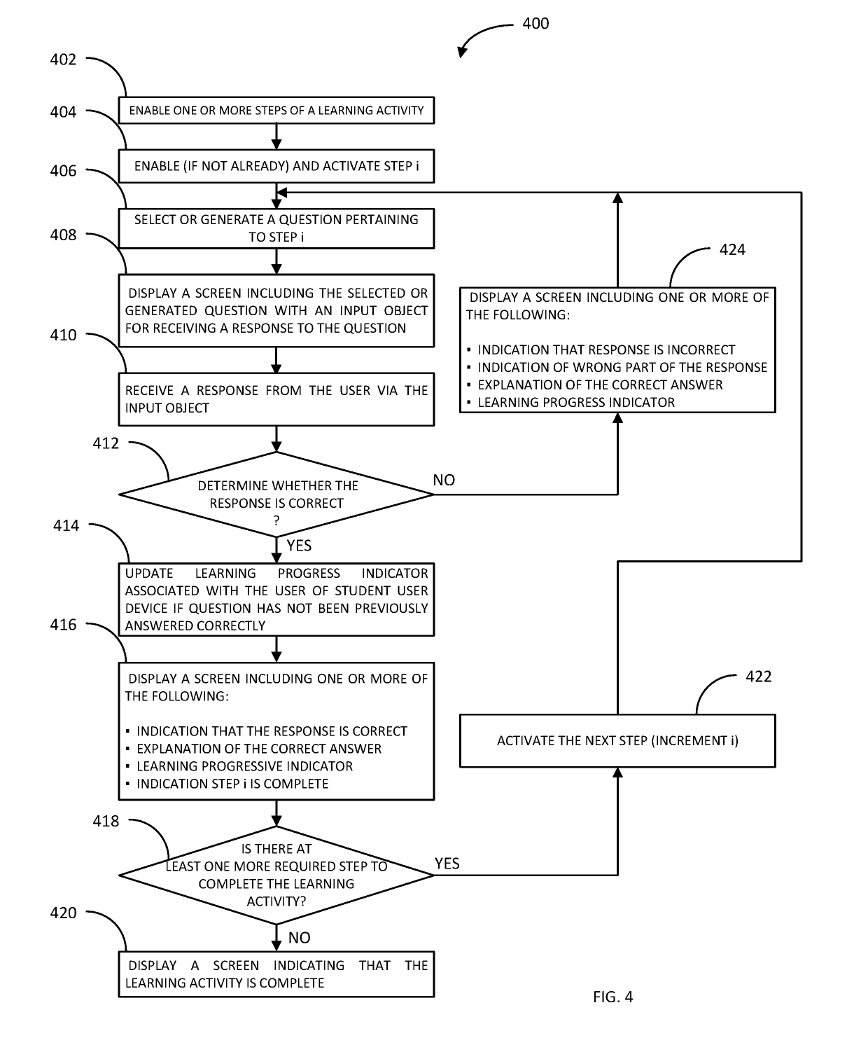

FIG. 4 illustrates a flow diagram of an exemplary method 400 of providing a learning activity in accordance with another aspect of the disclosure. As previously discussed, the learning tool server 120 or 200 may provide instructions to the student user device 130 or 300, for example, in the form of JavaScript or other types of control signals or commands, as well as data, so that the student user device 130 or 300 implements the particular learning activity. The learning tool server 120 or 200 may provide the entire instructions and needed data before the learning activity is commenced, or in segments as needed before and while the learning activity is in progress.

According to the method 400, the learning tool server 120 or 200 or student user device 130 or 300 (depending on which device performs this operation) enables one or more steps of the learning activity (block 402). Enabling a step means that the user may be able to activate the step for the purpose of completing the step. If a step is not enabled, the user may not be able to activate the step for the purpose of receiving a question. In the typical scenario, only the first step is enabled when the learning activity is initialized. However, one or more steps, besides the first step, may be enabled based on, for example, a learning progress metric or indicator pertaining to the user (which may be indicated in a corresponding student data object stored in the accessible memory 220 of the learning tool server 200). Or, one or more steps, besides the first step, may be enabled based on an adjustment to the student data object effectuated by a user of the instructor user device 140 or 300 through communications with the learning tool server.

As an example, if the learning progress metric or indicator in the student data object indicates that the user of the student user device 130 or 300 is not performing that well or there is no instructor adjustment indicated in the student data object, the learning tool server 120 or 200 or student user device 130 or 300 only enables the first step and not the remaining steps when the learning activity is initialized. The concept behind this is that a weaker student should be required to take all the steps of the learning activity to improve his/her understanding of the associated subject matter. If, on the other hand, the learning progress metric or indicator in the student data object indicates that the user is performing well or there is an instructor adjustment indicated in the student data object, the learning tool server or student user device may enable multiple (such as steps 1-3, and not step 4) or all of the steps (e.g., steps 1-4) when the learning activity is initialized. The concept behind this is that a stronger student is allowed to skip some steps as he/she may have already mastered the subject matter of the questions associated with the early steps.

According to the method 400, the learning tool server 120 or 200 or student user device 130 or 300 (depending on which device performs this operation) enables (if not already) and activates step i (block 404). As an example, when the learning activity is initiated, the first step (i=1) may be the only step enabled and activated. This may be the case where the user is required to complete all the steps of the learning activity. As another example, when the learning activity is initiated, the first step (i=1) may be enabled and activated, but there may be other one or more steps enabled but not activated. In such case, the user of the student user device may activate another enabled step (and the first step would be deactivated as only one step may be active at a time). This may be the case where the user is allowed to skip one or more of the steps, such as the first step, of the learning activity.

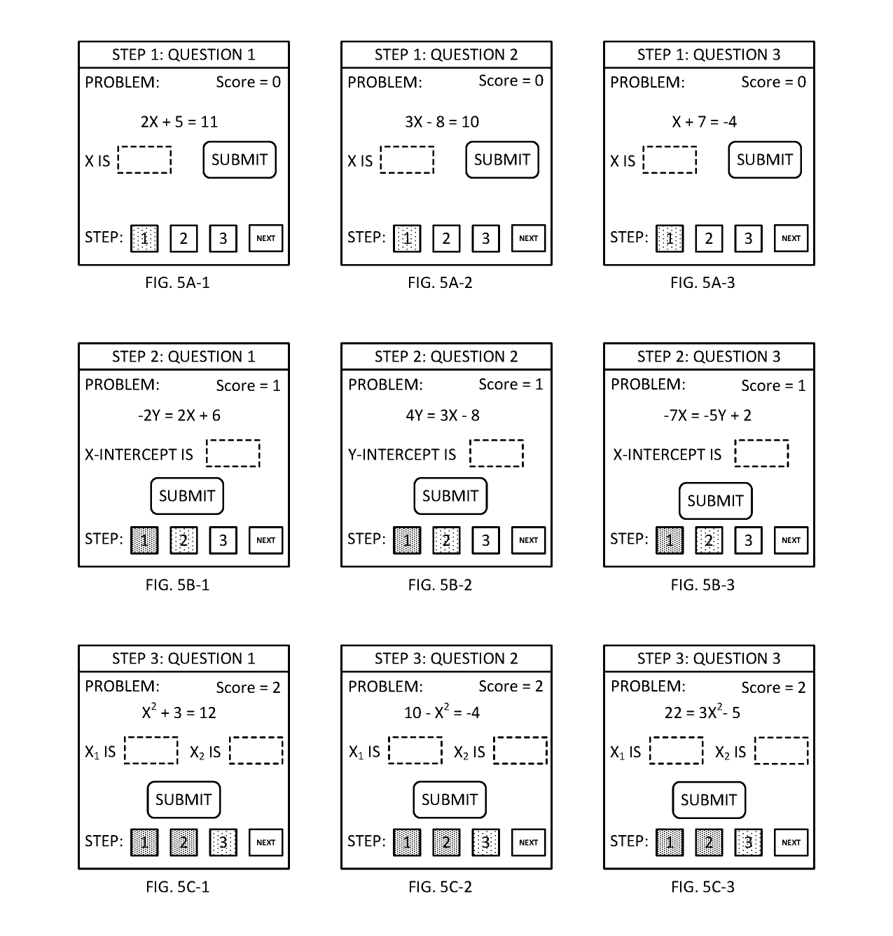

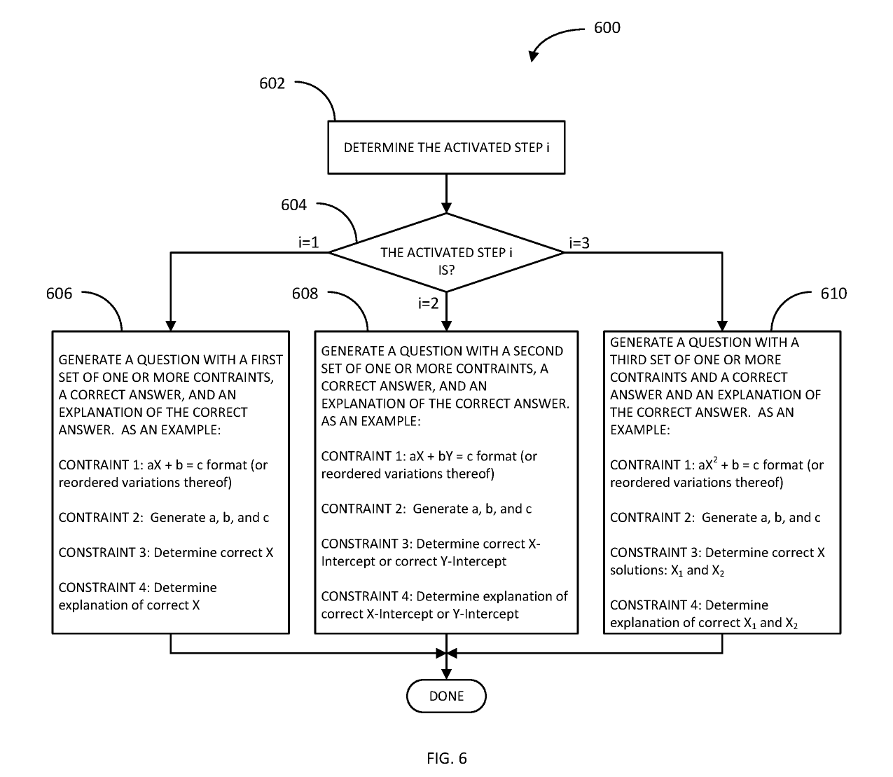

According to the method 400, the learning tool server 120 or 200 or the student user device 130 or 300 (depending on which device performs this operation), selects or generates a question pertaining to the active step i (block 406). The selected question may have been selected from a set of questions having a difficulty level pertaining to the active step i. This concept is illustrated below with reference to FIGS. 5A-5C. Alternatively, the question may have been generated using one or more constraints assigned to the active step i. This concept is illustrated below with reference to FIG. 6.

According to the method 400, the student user device 130 or 300 displays a screen on the user interface (display) 340 including the selected or generated question with an input object to receive a response to the question from the user (block 408). Examples of such screen are illustrated with reference to FIGS. 5A-5C, as discussed in more detail further herein. It shall be understood that the screen may include more than one input object as some questions may elicit more than one response.

According to the method 400, the student user device 130 or 300 receives the response from the user via the input object (block 410). Then, according to the method 400, the learning tool server 120 or 200 or the student user device 130 or 300 (depending on which device performs this operation) determines whether the response is correct (block 412). If the learning tool server is the device that performs this operation, the student user device sends the response submitted by the user to the learning tool server. If, on the other hand, the student user device performs the operation indicated in block 412, the student user device need not send the response to the learning tool server.

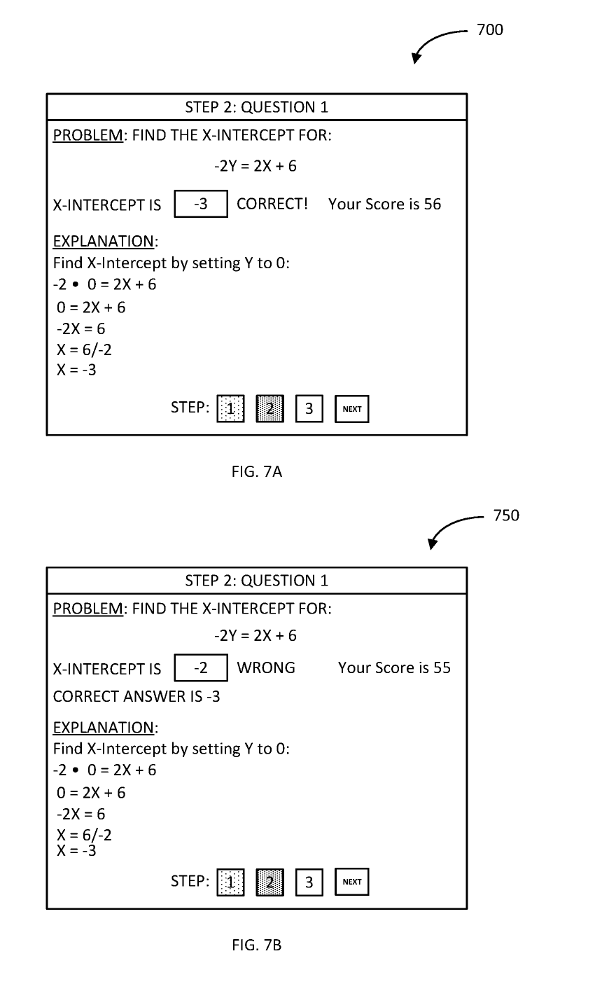

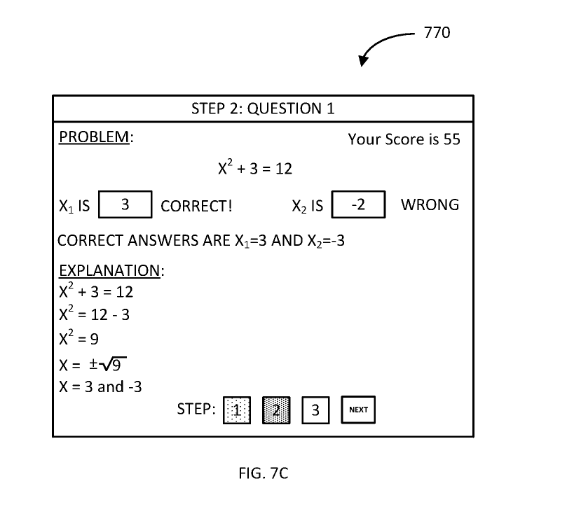

According to the method 400, the student user device 130 or 300, in response to receiving an incorrect response to the question, displays a screen on the user interface (display) 340 including one or more of the following: an indication that the response is incorrect, an indication of the wrong part of the response, an explanation of the correct solution or answer to the question, or a learning progress indicator (e.g., a score) (block 424). An example of such a screen is depicted in FIG. 7B described in more detail herein. With regard to the learning progress indicator (e.g., score), if the response is incorrect, the learning progress indicator (which may be indicated in the student data object) may not be changed. After block 424, the method 400 proceeds to block 406 to present the user another question associated with the current step i. In other words, if the user submits an incorrect response, he/she does not proceed to the next step.

According to the method 400, the learning tool server 120 or 200 or student user device 130 or 300 (depending on which device performs this operation), in response to receiving a correct response to the question, updates the learning progress indicator (e.g., score) pertaining to the user if a question pertaining to the current step i has not been previously answered correctly (block 414). As an example, the learning progress indicator (e.g., score) may be incremented by a certain value (e.g., one (1)). This keeps track of the learning progress or performance of the user. If the learning tool server performs the updating, the student user device may send a message to the server that the user submitted the correct response to the question associated with step i. This need not be performed at this time, but may be performed at the completion of the learning activity.

Further, if the user has previously completed the current step i, the learning tool server 120 or 200 or student user device 130 or 300 may not update the learning progress indicator (e.g., score). The concept here is that a user is allowed to retake at least one or more steps of the learning activity without the learning progress indicator (e.g., score) being affected. Accordingly, the learning progress indicator (e.g., score) is indicative of how many distinct steps have been completed.

According to the method 400, the student user device 130 or 300 presents a screen on the user interface (display) 340 including one or more of the following: an indication that the response is correct, an explanation of the correct solution or answer to the question, the learning progress indicator (e.g., a score), or an indication that step i is complete (block 416). An example of such a screen is depicted in FIG. 7A described in more detail herein.

According to the method 400, the learning tool server 120 or 200 or student user device 130 or 300 (depending on which device performs this operation), determines whether there is at least one more required step to complete the learning activity (block 418). For example, if the current step is the first step (i=1) and the user is required to take all of the steps (e.g., four (4)) of the learning activity, then the learning tool server or student user device determines that there are more required steps (e.g., steps 2-4) for the user to complete the learning activity. If, for example, the current step is the last step (e.g., i=4), then the learning tool server or student user device determines that there are no more required steps for the user to complete the learning activity.

According to the method 400, if it is determined that there is at least one more required step to complete the learning activity in block 418, the learning tool server 120 or 200 or student user device 130 or 300 activates the next step (e.g., increments the current step i) (block 422). The concept here is that if the user completes the current step, he/she is allowed to proceed to the next step. The method 400 then proceeds to block 406 and continues on therefrom as previously discussed. If it is determined that that there are no more required steps to complete the learning activity in block 418, the student user device presents a screen on the user interface (display) 340 indicating that the learning activity is complete (block 420).

FIGS. 5A-1 to 5A-3 illustrate a first set of exemplary screens of questions related to a first step of a learning activity in accordance with another aspect of the disclosure. Each of these screens is an example of a screen that the student user device 130 or 300 may display on the user interface (display) 340 per block 408. As illustrated, each of the screens includes a question, such as what is the variable X in the equation 2X+5=11 (See e.g., FIG. 5A-1). Each of the screens also includes an input object for receiving a response to the question from the user. As illustrated, the input object is configured as a textbox (represented by the dashed box) to receive a response from the user, and a submit button to send the response to the user device processor 310 when the button is activated (e.g., clicked on with a pointing device or the enter key on a keyboard is pressed).

Each of the screens also provides a listing of all the steps in a learning activity. In the example of FIGS. 5A-1 to 5A-3, there are three (3) steps in the learning activity (e.g., represented as boxes labeled “1”, “2”, and “3”). In this example, the shading of each step box indicates whether the step is not active or disabled (e.g., no shading), active (e.g., light shading), or completed (e.g., dark shading). For instance, the exemplary screens depicted in FIGS. 5A-1 to 5A-3 indicate that their respective step 1 is active, and steps 2 and 3 are not active or disabled. Accordingly, each of these screens may be an example of a question screen presented to a user pursuant to step 1. As such, the learning progress indicator (e.g., Score) for the current learning activity may be at zero (0) as the user has not completed any of the steps. Alternatively, the learning progress indicator may just be the number of boxes with dark shading, without a Score or numeric value indicated. Each of the screens may include the “NEXT” button to activate the following enabled step (if any) in an incremental fashion. Alternatively, or in addition to, a user may activate an enabled step by activating the corresponding step box, which, in such case, function as an activation button as well.

The screens of FIGS. 5A-1 to 5A-3 illustrate exemplary questions assigned to step 1. In this example, the exemplary questions are linear equations with a single variable X. Such questions may be part of set of questions assigned to step 1, which may be stored in a database, such as the accessible server memory 220 previously discussed. In block 406 of the method 400 previously discussed, the selection of a question may involve selecting one of the questions, such as those depicted in FIGS. 5A-1 to 5A-3, assigned to step 1.

FIGS. 5B-1 to 5B-3 illustrate a second set of exemplary screens of questions related to a second step of the learning activity in accordance with another aspect of the disclosure. These screens are structurally similar to those of screens depicted in FIGS. 5A-1 to 5A-3. In this example, the box associated with step 1 of the screens has dark shading, which indicates that step 1 has been completed by the user. In this regard, the learning progress indicator (e.g., Score) for the current learning activity is equal to one (1). Thus, in one aspect, the Score may be equal to the number of boxes having dark shading; indicating the number of steps that have been completed. The box associated with step 2 of the screens has light shading, which indicates that step 2 is active. And, the box associated with step 3 of the screens has no shading, which indicates that step 3 is not active or disabled. Each of the screens may be the case where a user has successfully completed step 1 and is presented a new question associated with step 2. As step 1 has been completed, a user may retry step 1 again by activating the step 1 box-button.

The screens of FIGS. 5B-1 to 5B-3 illustrate exemplary questions assigned to step 2. In this example, the exemplary questions are linear equations having two variables X and Y, and involve solving the X- or Y-intercepts of the questions, respectively. Such questions may be part of a set of questions assigned to step 2, which may be stored in a database, such as the accessible server memory 220 previously discussed. In block 406 of the method 400 previously discussed, the selection of a question may involve selecting one of the questions, such as those depicted in FIGS. 5B-1 to 5B-3, assigned to step 2. As indicated, the difficulty level of the questions assigned to step 2 may be greater than the difficulty level of the questions assigned to step 1 (e.g., involves two variables compared to one variable). Thus, the learning activity may be structured to have progressively more difficult steps.

FIGS. 5C-1 to 5C-3 illustrate a third set of exemplary screens of questions related to a third step of the learning activity in accordance with another aspect of the disclosure. These screens are structurally similar to those of screens depicted in FIGS. 5A-1 to 5A-3 and 5B-1-5B-3. In this example, the boxes associated with steps 1 and 2 of the screens have dark shading, which indicates that steps 1 and 2 have been completed by the user. In this regard, the learning progress indicator (e.g., Score) for the current learning activity is equal to two (2). Again, as discussed, the Score may be equal to the number of boxes having dark shading; indicating the number of steps that have been completed. The box associated with step 3 of the screens has light shading, which indicates that step 3 is active. Each of the screens may be the case where a user has successfully completed steps 1 and 2, and is presented a new question associated with step 3. As steps 1 and 2 are have been completed, a user may retry step 1 and/or step 2 again by activating the step 1 and/or step 2 box-buttons.

The screens of FIGS. 5C-1 to 5C-3 illustrate exemplary questions assigned to step 3. In this example, the exemplary questions are quadratic equations having a single variable, and involve finding both solutions X₁ and X₂ of the questions, respectively. Such questions may be part of a set of questions assigned to step 3, which may be stored in a database, such as the accessible server memory 220 previously discussed. In block 406 of the method 400 previously discussed, the selection of a question may involve selecting one of the questions, such as those depicted in FIGS. 5C-1 to 5C-3, assigned to step 3. As indicated, the difficulty level of the questions assigned to step 3 may be greater than the difficulty level of the questions assigned to step 2 (e.g., involves a quadratic equation with two solutions compared to a linear equation with one solution). Thus, the learning activity may be structured to have progressively more difficult steps.

FIG. 6 illustrates a flow diagram of an exemplary method 600 of generating questions based on first, second, and third sets of constraints related respectively to first, second, and third steps of a learning activity in accordance with another aspect of the disclosure. The method 600 may be an exemplary more detailed implementation of generating a question pertaining to the current step i, as indicated in block 406 of the method 400.

According to the method 600, the learning tool server 120 or 200 or the student user device 130 or 300 (depending on which device performs this operation) determines the activated step i (block 602). If it is determined that the current step i is step 1 as indicated in block 604, the learning tool server or student user device generates a question based on a first set of one or more constraints, a correct answer for the question, and an explanation of the correct answer (block 606).

As an example, the first set of one or more constraints may include: Constraint 1: indicating a linear equation with the format aX+b=c (or a reordered variation of the equation, such as aX=b+c), where X is a variable and a, b, and c are constants; Constraint 2: where the constants a, b, and c are generated (e.g., randomly generated); Constraint 3: where the correct answer X is determined based on the generated constants a, b, and c; and Constraint 4: where an explanation of the correct answer is provided (an example of an explanation of the correct answer is shown in FIG. 7A discussed further herein). Based on these constraints, a question such as those depicted in screens of FIGS. 5A-1 to 5A-3 may be generated. If the learning tool server 120 or 200 is the device that generates the question, the learning tool server then sends the generated question to the student user device 130 or 300 for displaying per block 408 of the method 400. Once the question is generated, the method 600 is done until reinitialized per another execution of block 406.

If it is determined that the current step i is step 2 as indicated in block 604, the learning tool server 120 or 200 or student user device 130 or 300 (depending on which device performs this operation) generates a question based on a second set of one or more constraints, a correct answer for the question, and an explanation of the correct answer (block 608).

As an example, the second set of one or more constraints may include: Constraint 1: indicating a linear equation with the format aX+bY=c (or a reordered variation of the equation, such as aX=bY+c), where X and Y are variables, and a, b, and c are constants; Constraint 2: where the constants a, b, and c are generated (e.g., randomly generated); Constraint 3: where the correct answer X-Intercept or Y-Intercept is determined based on the generated constants a, b, and c; and Constraint 4: where an explanation of the correct answer is provided. Based on these constraints, a question such as those depicted in screens of FIGS. 5B-1 to 5B-3 may be generated. If the learning tool server 120 or 200 is the device that generates the question, the learning tool server then sends the generated question to the student user device 130 or 300 for displaying per block 408 of the method 400. Once the question is generated, the method 600 is done until reinitialized per another execution of block 406.

Similarly, if it is determined that the current step i is step 3 as indicated in block 604, the learning tool server 120 or 200 or student user device 130 or 300 (depending on which device performs this operation) generates a question based on a third set of one or more constraints, a correct answer for the question, and an explanation of the correct answer (block 610).

As an example, the third set of one or more constraints may include: Constraint 1: indicating a quadratic equation with the format aX²+b=c (or a reordered variation of the equation, such as aX²=b+c), where X is a variable and a, b, and c are constants; Constraint 2: where the constants a, b, and c are generated (e.g., randomly generated); Constraint 3: where the correct answers X₁ and X₂ are determined based on the generated constants a, b, and c; and Constraint 4: where an explanation of the correct answer is provided. Based on these constraints, a question such as those depicted in screens of FIGS. 5C-1 to 5C-3 may be generated. If the learning tool server 120 or 200 is the device that generates the question, the learning tool server then sends the generated question to the student user device 130 or 300 for displaying per block 408 of the method 400. Once the question is generated, the method 600 is done until reinitialized per another execution of block 406.

FIG. 7A illustrates an exemplary screen 700 after submission of a correct response to a question of a learning activity in accordance with another aspect of the disclosure. The screen 700 is an example of a screen that the student user device 130 or 300 may present on the user interface (display) 340 per block 416 of method 400. As illustrated, screen 700 includes the question (e.g., −2Y=2X+6, find X-Intercept), the response submitted by the user (e.g., −3), an indication that the response is correct (e.g., CORRECT!), the learning progress indicator (e.g., Your Score is 56), and an explanation of the correct answer (e.g., Find X-Intercept by setting Y to 0 . . . X=−3). The screen 700 also includes the step indication and navigation buttons (e.g., STEP: 1 2 3 NEXT) as previously discussed. It shall be understood that the screen 700 may be configured differently, and may include less or more information than indicated.

FIG. 7B illustrates an exemplary screen 750 after submission of an incorrect response to a question of a learning activity in accordance with another aspect of the disclosure. The screen 750 is an example of a screen that the student user device 130 or 300 may present on the user interface (display) 340 per block 424 of method 400. As illustrated, screen 750 includes the question (e.g., −2Y=2X+6, find X-Intercept), the response submitted by the user (e.g., −2), an indication that the response is incorrect (e.g., WRONG), the learning progress indicator (e.g., Your Score is 55), and an explanation of the correct answer (e.g., Find X-Intercept by setting Y to 0 . . . X=−3). The screen 750 also includes the step indication and navigation buttons (e.g., STEP: 1 2 3 NEXT) as previously discussed. It shall be understood that the screen 700 may be configured differently, and may include less or more information than indicated.

FIG. 7C illustrates another exemplary screen 770 after submission of an incorrect response to a question of a learning activity in accordance with another aspect of the disclosure. The screen 770 is an example of a screen that the student user device 130 or 300 may present on the user interface (display) 340 per block 424 of method 400. In this example, screen 770 presents a question that elicits two responses (e.g., X²+3=12, find X₁ and X₂), the responses to X₁ and X₂ submitted by the user (e.g., −3 and −2), an indication that the response to X₁ is correct (e.g., CORRECT!) and the response to X₂ is incorrect (e.g., WRONG) (i.e., the wrong part of the responses), the correct answers (e.g., THE CORRECT ANSWERS ARE X₁=3 AND X₂=−3), the learning progress indicator (e.g., Your Score is 55), and an explanation of the correct answer (e.g., X²+3=12 . . . X=3 and −3). The screen 770 also includes the step indication and navigation buttons (e.g., STEP: 1 2 3 NEXT) as previously discussed. It shall be understood that the screen 770 may be configured differently, and may include less or more information than indicated.

### Presentation of Topics Based on Response to Question(s)

A wrong answer to a question may indicate a lack of understanding of one or more topics. Informing a student of those topics helps the student know what topics to study. Furthermore, indicating the relative importance of those topics helps the student choose where to focus the student's available time.

Studies also show that taking a quiz before studying topics can improve a student's subsequent learning of those topics.

The following proposed approach strikes a balance between structured material and adaptive material. The student's quiz results are analyzed and the student is presented with a list of topics that the student should study, with relative importance of those topics indicated, with links to those topics, and even with an indication of whether the student has completed those topics.

In summary, a teaching system presents topics to a user for learning. In particular, the system provides a user a quiz with questions that the user answers, and receives a score based on the correctness of the answers. Additionally, based on one or more of the user's answers, one or more suggested topics to study are listed. At least one of the suggested topics includes a hyperlink to the topic's presentation or content.

In some aspects, each listed topic includes an associated number, with the number's magnitude indicating the importance of that topic based on the user's answer. In other aspects, each listed topic includes an associated visual feature, with the visual feature indicating the importance of that topic based on the student's answers. For example, the visual feature may be text size of the topic, where the importance of the topic is proportionally related to the text size. As another example, the visual feature may be the color of the text of the topic, where the hue of the color indicates the importance of the topic. In other aspects, the order in which the topics are listed indicates the relative importance of the topics (e.g., most important listed first and least important listed last).

In some aspects, the system, upon a user completing a study of a listed topic, the topic in the list of topics is indicated as being completed. In other aspects, the system, upon a user completing studying the topic, returns the user to the list of topics in response to a single click or activation of a hyperlink.

In some aspects, the one or more suggested topics are associated with a particular question. In other aspects, the one or more suggested topics are associated with a group of questions. In other aspects, the determination of the list of topics is based on a submitted answer (response) to a single question. In other aspects, the determination of the list of topics is based on a plurality of submitted answers (responses) to multiple questions.

In some aspects, the system provides an exercise, quiz or other learning assessment item to the user after the user has studied the topics covered by the item. In other aspects, the system provides the exercise, quiz or other learning assessment item to the user before the user studies topics covered by the item.

The following provides description of flowcharts and display screens for exemplifying the aforementioned concepts related to displaying one or more topics based on one or more responses to one or more questions, respectively.

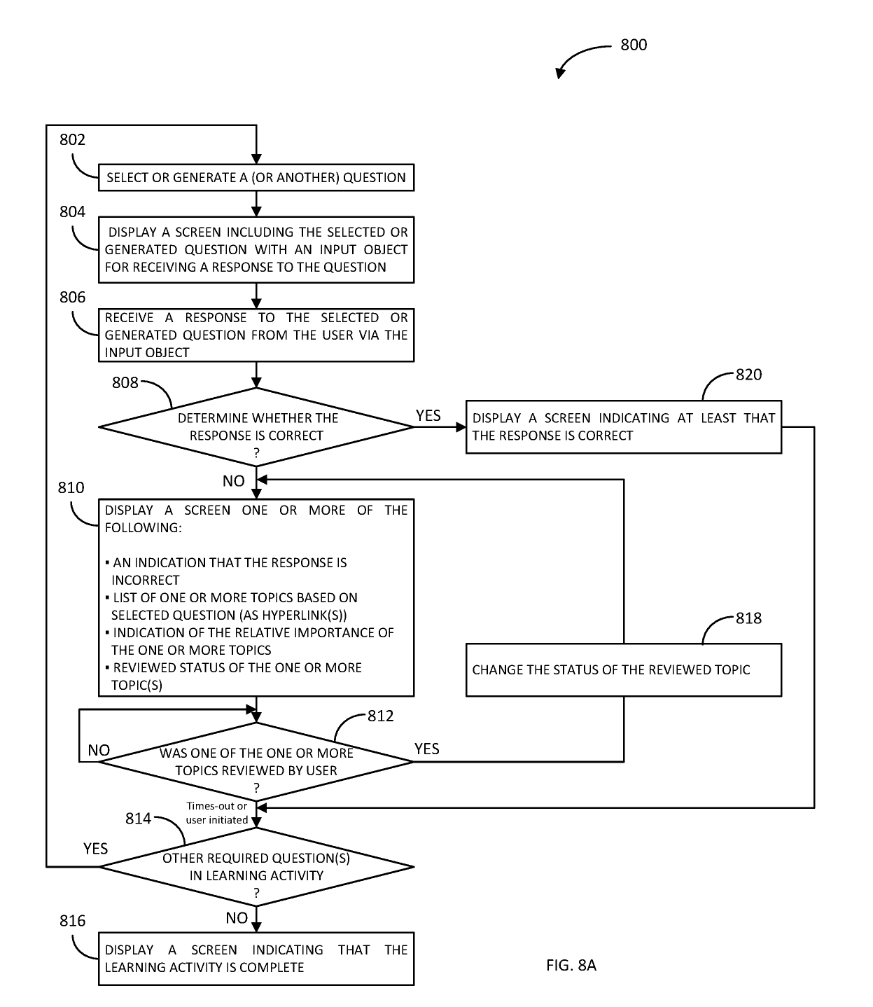

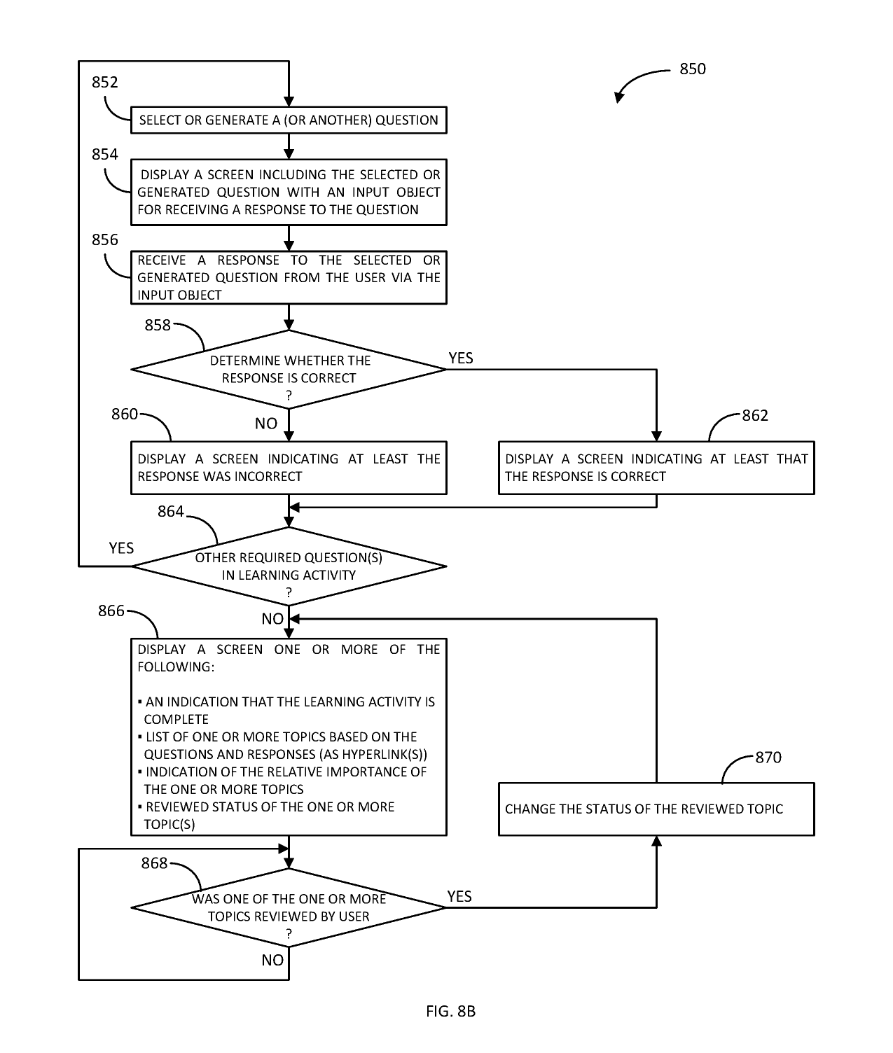

FIG. 8A illustrates a flow diagram of another exemplary method 800 of providing a learning activity that presents one or more topics in response to a response to a question in accordance with another aspect of the disclosure. Similar to the method 400, the learning tool server 120 or 200 may provide instructions to the student user device 130 or 300, for example, in the form of JavaScript or other types of control signals or commands, as well as data, so that the student user device 130 or 300 implements the particular learning activity. The learning tool server 120 or 200 may provide the entire instructions and needed data before the learning activity is commenced, or in segments as needed before and while the learning activity is in progress.

According to the method 800, the learning tool server 120 or 200 or student user device 130 or 300 (depending on which device performs this operation), selects or generates a (or another) question (block 802). The selection or generation of the question may be performed pursuant to a learning activity initiated by a user of the student user device. The selection of the question may be performed in a similar manner discussed with references to FIGS. 5A-5C (e.g., from a database of premade questions). Alternatively, the question may be generated based on a set of one or more constraints similar to the method 600 previously discussed.

Then, according to the method 800, the student user device 130 or 300 displays a screen including the selected or generated question and an input object for receiving a response to the selected or generated question (block 804). The screen may be configured similar to any of the exemplary screens described with reference to FIGS. 5A-5C. Further, according to the method 800, the student user device 130 or 300 receives the response to the selected question from the user via the input object (block 806).

According to the method 800, the learning tool server 120 or 200 or student user device 130 or 300 (depending on which device performs this operation) determines whether the response submitted by the user via the input object is correct (block 808). If the learning tool server makes such determination, the student user device sends the response to the learning tool server.

If it is determined that the response is correct, the student user device 130 or 300 displays a screen on the user interface (display) 340 indicating at least that the response is correct (block 820). If the learning tool server 120 or 200 is the device that makes the determination, the learning tool server sends a message to the student user device indicating that the response is correct. In response to receiving the message, the student user device presents the screen per block 820.

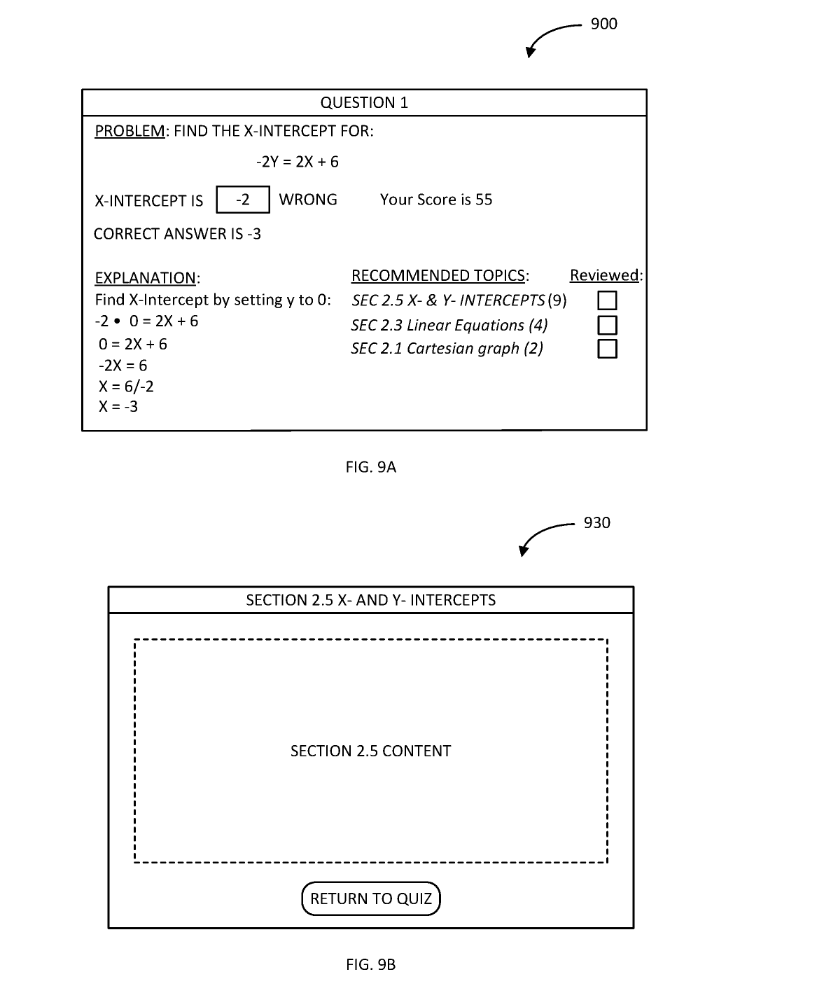

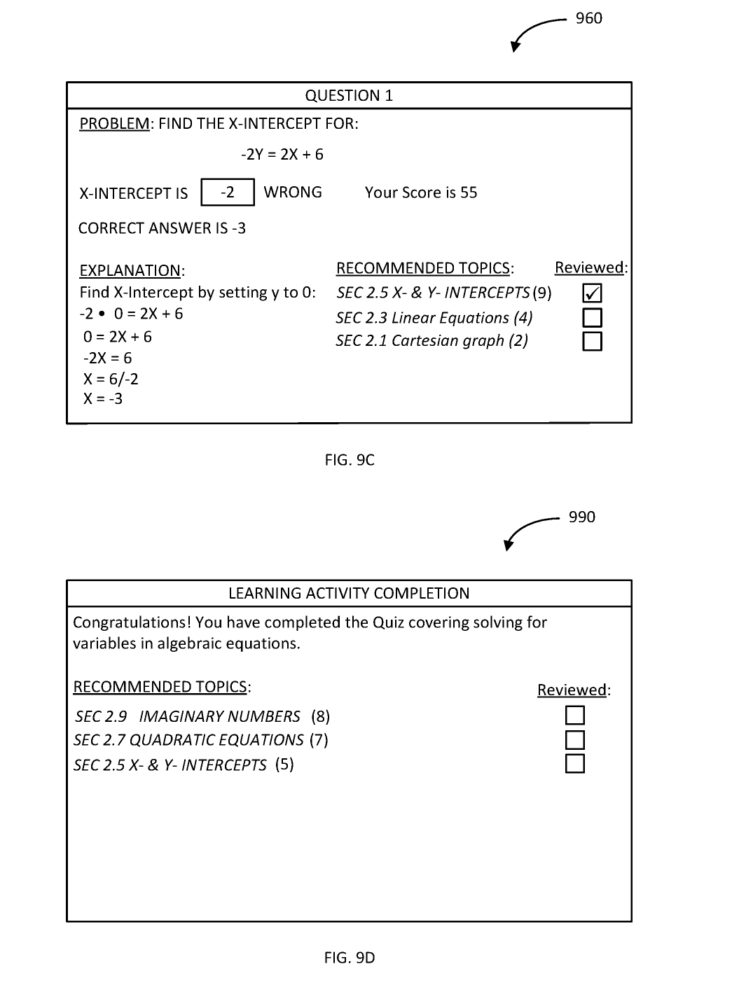

If it is determined that the response is incorrect, the student user device 130 or 300 presents a screen on the user interface (display) 340 including one or more of the following: (1) an indication that the response is incorrect; (2) a list of one or more topics (as hyperlinks) related to the selected or generated question; (3) an indication of the relative importance of the one or more topics; or (4) a reviewed status of each of the one or more topics (block 810). The screen may be configured similar to screen 900 depicted in FIG. 9A, as discussed in more detail further herein. Similarly, if the learning tool server 120 or 200 is the device that makes the determination, the learning tool server sends a message to the student user device indicating that the response is incorrect. In response to receiving the message, the student user device presents the screen per block 810.

According to the method 800, the learning tool server 120 or 200 or student user device 130 or 300 (depending on which device performs this operation) determines whether the user has reviewed one of the topics of the list (block 812). As discussed, each of the one or more topics of the list may be configured as a hyperlink. When the user activates one of the hyperlinks of a topic, the student user device 130 or 300 presents a screen on the user interface (display) 340 including the content associated with the topic. An example of such screen is screen 930 depicted in FIG. 9B, as discussed in more detail further herein. When the user has reviewed the content and has activated a return hyperlink on the topic screen, the learning tool server or student user device determines that the user has reviewed the topic per block 812.

Accordingly, if in block 812, the learning tool server or student user device determines that the user has reviewed one of the topics, the server or user device changes the status of the topic as being reviewed (block 818), and the method 800 returns to block 810 where the student user device presents an updated screen on the user interface (display) 340 indicating that such topic has been reviewed. An example of an updated screen is screen 960 depicted in FIG. 9C, as discussed in more detail further herein. The operations indicated in blocks 812, 818, and 810 may be repeated as the user selects and reviews additional topics of the list. If, in block 812, the learning tool server or student user device has not determined that the user has reviewed one of the topics, the student user device continues to display the initial screen per block 810 (e.g., no topics is indicated as being reviewed).

According to the method 800, after block 812 (based on a timed-out period or user initiated), the learning tool server 120 or 200 or student user device 130 or 300 (depending on which device performs this operation) may determine whether there are other one or more remaining questions of the learning activity (block 814). The operation indicated in block 814 may be performed after the student user device performs the operation indicated in block 820. If it is determined that there are other one or more remaining questions, the method 800 returns to block 802 to repeat the process for another question. If, on the other hand, there are no other question, the student user device may present a screen on the user interface (display) 340 including an indication that the learning activity is complete (block 816).

FIG. 8B illustrates a flow diagram of another exemplary method 850 of providing a learning activity that presents one or more topics in response to a response to a question in accordance with another aspect of the disclosure. The method 850 is similar to the method 800, but the list of one or more topics and associated information is based on a set of responses to a set of multiple questions. For example, the list of one or more topics may be provided to the user after completion of a learning activity including a plurality of questions.

Similar to method 800, the method 850 includes the learning tool server 120 or 200 or student user device 130 or 300 (depending on which device performs this operation), selecting or generating a (or another) question (block 852); the student user device displaying a screen including the selected or generated question and an input object for receiving a response to the selected question (block 854); the student user device receiving the response to the selected or generated question from the user via the input object (block 856); and the learning tool server or student user device 130 or 300 determining whether the response submitted by the user via the input object is correct (block 858).

Further, according to the method 850, if it is determined that a correct response was submitted, the student user device 130 or 300 presents a screen on the user interface (display) 340 indicating that the response is correct (block 862). If, on the other hand, it is determined that an incorrect response was submitted, the student user device 130 or 300 presents a screen on the user interface (display) 340 indicating that the response is incorrect (block 860). An example of such a screen may be screen 900 discussed further herein.

According to the method 850, the learning tool server 120 or 200 or student user device 130 or 300 (depending on which device performs this operation) may determine whether there are other one or more remaining questions of the learning activity (block 864). If it is determined that there are other one or more remaining questions, the method 850 returns to block 852 to repeat the process for another question.

If, on the other hand, there are no more question, the student user device may present a screen on the user interface (display) 340 including one or more of the following: (1) an indication that the learning activity is complete; (2) a list of one or more topics (as hyperlinks) based on at least some of the responses (e.g., incorrect responses) to the questions of the learning activity; (3) an indication of the relative importance of the one or more topics; or (4) a reviewed status of each of the one or more topics (block 866). The screen may be configured similar to screen 990 depicted in FIG. 9D, as discussed in more detail further herein. Similar to method 800, if the learning tool server 120 or 200 is the device that makes the determination, the learning tool server sends a message to the student user device indicating that the response is incorrect. In response to receiving the message, the student user device presents the screen per block 866.

Similar to method 800, the method 850 includes the learning tool server 120 or 200 or student user device 130 or 300 (depending on which device performs this operation) determining whether the user has reviewed one of the topics of the list (block 868). If in block 868, the learning tool server or student user device determines that the user has reviewed one of the topics, the server or user device changes the status of the topic as being reviewed (block 870), and the method 850 returns to block 866 where the student user device presents an updated screen on the user interface (display) 340 indicating that such topic has been reviewed.

The operations indicated in blocks 868, 870, and 866 may be repeated as the user selects and reviews additional topics of the list. If, in block 868, the learning tool server or student user device has not determined that the user has reviewed one of the topics, the student user device continues to display the initial screen per block 866 (e.g., no topics is indicated as being reviewed).

FIG. 9A illustrates an exemplary screen 900 after submission of an incorrect response to a question of a learning activity in accordance with another aspect of the disclosure. As previously discussed, the screen 900 may be a detailed implementation of the screen displayed per block 810 of the method 800. As illustrated, the screen 900 includes the question (e.g., −2Y=2X+6, find X-Intercept), the response submitted by the user (e.g., −2), an indication that the response is incorrect (e.g., WRONG), the correct answer (e.g., CORRECT ANSWER IS −3), the learning progress indicator (e.g., Your Score is 55), and an explanation of the correct answer (e.g., Find X-Intercept by setting Y to 0 . . . X=−3).

The screen 900 further includes a list of recommended topics (e.g., SEC. 2.5 X- & Y-INTERCEPTS, SEC. 2.3 Linear Equations, and SEC 2.1 Cartesian graph) based on the incorrect response (e.g., −2) to question 1. Each of the listed topics may be configured as a hyperlink. Additionally, the screen 900 includes indications of the relative importance of the listed topics (e.g., (9), (4), and (2)) juxtaposed next to the corresponding topics). In this example, the magnitude of the number is proportional to the importance of the topic. A user should review the topic with the highest importance indicator first and more carefully, than other topics with lower importance indicators. Further, the screen 900 includes indications as to whether the corresponding topics have been reviewed. In this example, the “Reviewed:” section includes three check boxes juxtaposed next to the corresponding topics. When any of the check boxes include a check, the corresponding topic is indicated as having been reviewed by the user.

FIG. 9B illustrates an exemplary screen 930 of a presentation or content of a topic accessed by a user by activating a topic hyperlink present in screen 900 in accordance with another aspect of the disclosure. In this example, the screen 930 includes the presentation or content associated with the activated topic hyperlink (e.g., SECTION 2.5 CONTENT). Additionally, the screen includes a return hyperlink (e.g., RETURN TO QUIZ), which the user may activate after reviewing the content to return back to the learning activity. As previously discussed with reference to methods 800 and 850, when the user activates the return hyperlink, the learning tool server 120 or 200 or the student user device 130 or 300 determines that the user has reviewed one of the listed topics per blocks 812 and 868, respectively.

FIG. 9C illustrates an exemplary screen 960 after activating the return hyperlink (e.g., RETURN TO QUIZ) in screen 930 in accordance with another aspect of the disclosure. As discussed with reference to methods 800 and 850, the learning tool server 120 or 200 or student user device 130 or 300 changes the status of the topic associated with the return hyperlink to as having been reviewed per blocks 818 and 870, respectively. As illustrated, the screen 960 is similar to screen 900, except that the check box associated with the topic, SEC 2.5 X- & Y-INTERCEPTS includes a check to indicate that the topic has been reviewed. Since the other check boxes do not include checks, this indicates that the corresponding topics, SEC 2.3 Linear Equations and SEC 2.1 Cartesian graph, have not been reviewed by the user.

FIG. 9D illustrates an exemplary screen 990 after completion of a learning activity (e.g., exercise or quiz) in accordance with another aspect of the disclosure. The screen 990 may be a detailed implementation of the screen displayed per block 868 of the method 850. That is, the screen 990 includes an indication that the learning activity is complete (e.g., Congratulations! You have completed the Quiz covering solving for variables in algebraic equations). Additionally, similar to screen 900, the screen 990 includes a list of recommended topics (e.g., SEC 2.0 IMAGINARY NUMBERS, SEC 2.7 QUADRATIC EQUATIONS, and SEC 2.5 X- & Y-INTERCEPTS) with associated (juxtaposed) topic importance indicators (e.g., (8), (7), and (5)), and corresponding reviewed status check boxes.

### Exercise or Quiz Generator Based on User Inputs

Student learning is aided by self-assessment, such as by taking a quiz. The student's quiz score informs the students of their level of mastery, and indicates what topics need study.

Currently quizzing systems are quite limited. They typically cover specific topics (e.g., specific chapters or sections) as determined by an author or an instructor. They typically have a particular length and particular difficulty level. Needed is the ability for a student to create custom quizzes, by selecting topics, quiz length, and difficulty level. Existing quiz creation systems are designed for instructors, not students. Existing self-assessment items are typically not configurable.

In summary, a system is provided where topics can be learned by a user. The system provides: means for generating a quiz including questions to which a user submits answers (responses), and receiving a score based on correctness of the submitted answers. The system also provides means for a user to select one or more of the following assessment features: (1) topics; (2) number of questions; and (3) difficulty level of the questions. Based on the aforementioned assessment features inputted by a user, the system generates one or more quizzes.

In some aspects, the system presents each question with a difficulty of the question indicator. In other aspects, the system selects questions for a user from questions that the user may have previously completed. In other aspects, the system selects questions for a user from a database of questions. In other aspects, the system automatically generates questions for a user based on one or more parameters that result in a unique question.

In some aspects, the system provides the quiz generating learning assessment to the user after the user has studied the submitted topics. In other aspects, the system provides the quiz generating learning assessment to the user before the user studies the submitted topics.

The following provides description of flowcharts and display screens for exemplifying the aforementioned concepts related to generating learning activities (e.g., quizzes) based on one or more user-submitted responses or a user learning progress metric.

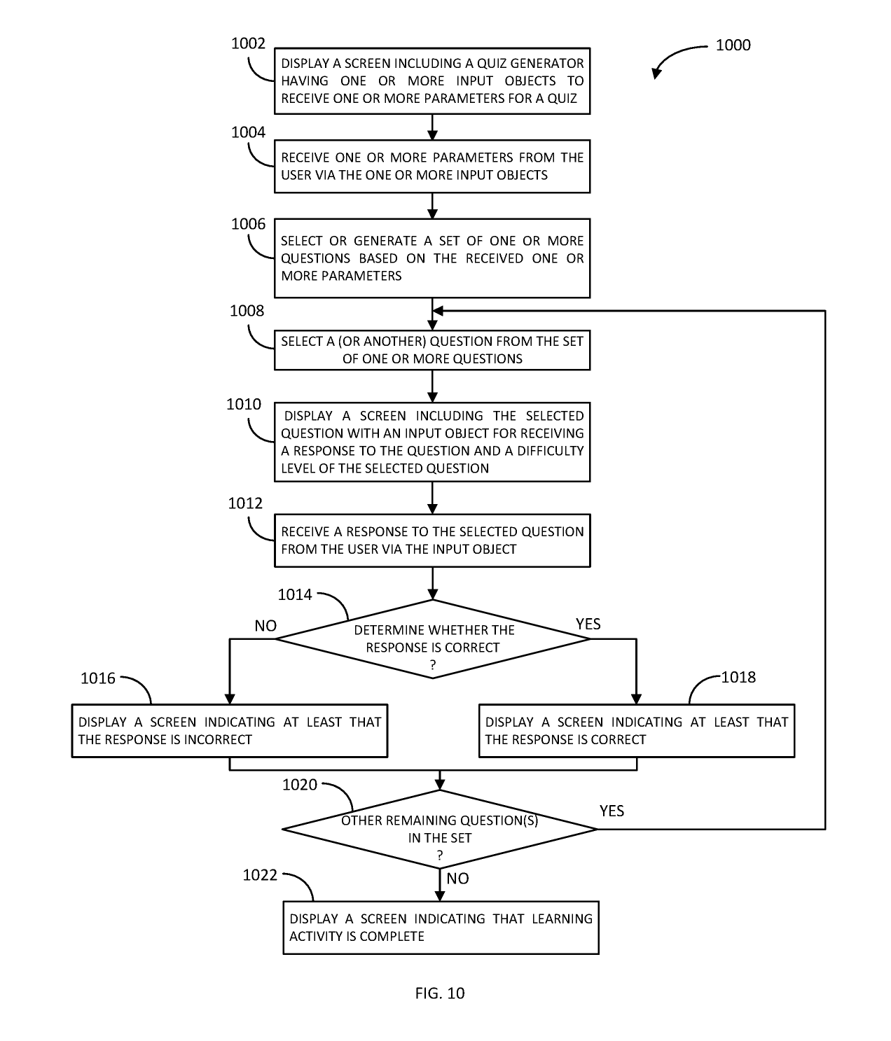

FIG. 10 illustrates a flow diagram of an exemplary method 1000 for generating a learning activity (e.g., quiz) based on one or more parameters provided by a user in accordance with another aspect of the disclosure. Similar to the previous methods, the learning tool server 120 or 200 may provide instructions to the student user device 130 or 300, for example, in the form of JavaScript or other types of control signals or commands, as well as data, so that the student user device 130 or 300 implements the particular learning activity. The learning tool server 120 or 200 may provide the entire instructions and needed data before the learning activity is commenced, or in segments as needed before and while the learning activity is in progress.

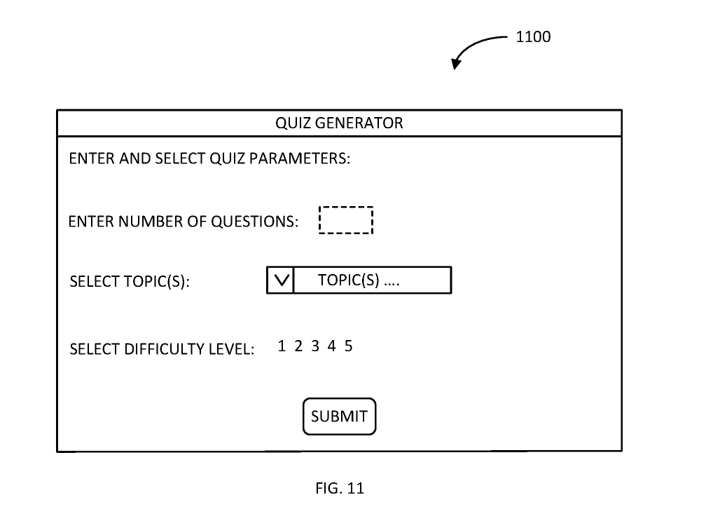

According to the method 1000, the student user device 130 or 300 displays a screen on the user interface (display) 340, the screen including a quiz generator having one or more input objects to receive one or more parameters that control how a quiz is to be generated, respectively (block 1002). An example of such a screen is screen 1100 depicted in FIG. 11, as discussed in more detail further herein. Examples of such parameters include the number of questions, the topic of the questions to be generated pursuant to the quiz, and the difficulty level of the questions. The concept here is to allow the user-student to generate a quiz as desired to meet his/her learning needs.

According to the method 1000, the student user device 130 or 300 receives the one or more parameters from the user via the one or more input objects, respectively (block 1004). The, the learning tool server 120 or 200 or the student user device (depending on which device performs this operation) selects or generates a set of one or more questions based on the one or more parameters (block 1006). If the learning tool server is the device that performs this operation, the student user device communicates the one or more parameters to the learning tools server.

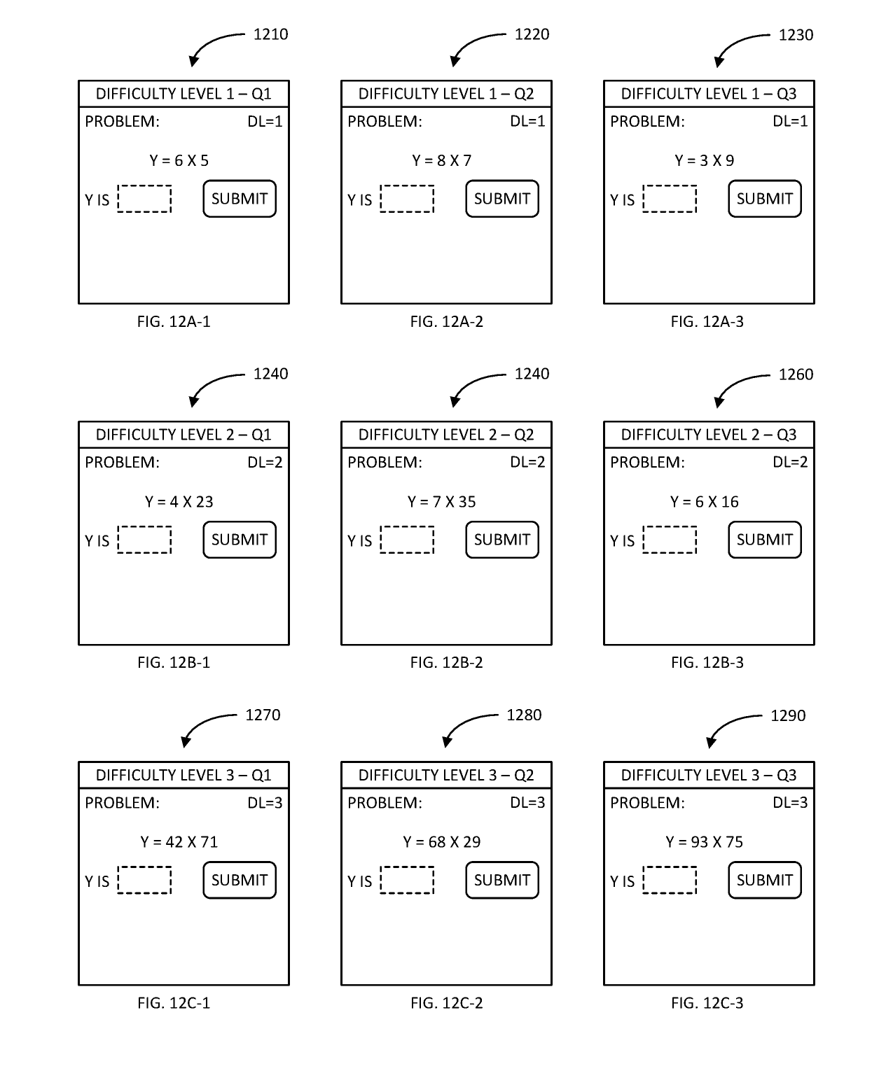

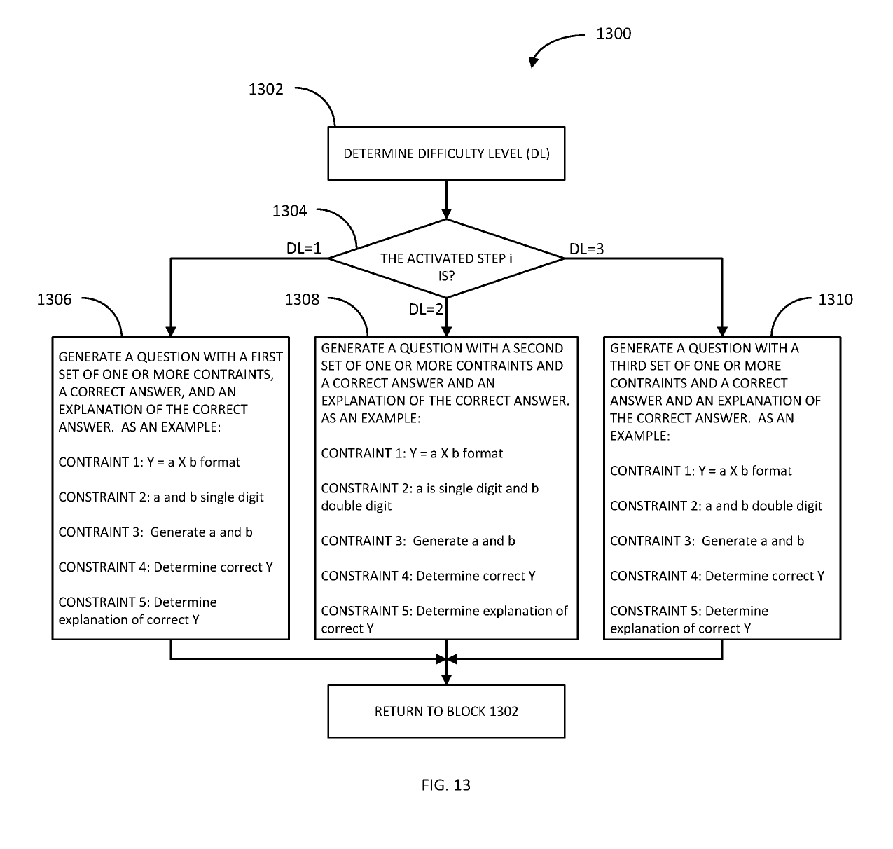

As discussed further herein with reference to FIGS. 12A-12C, the selection of the questions may be based on questions stored in a database. Also, the questions may be selected from questions the user has previously reviewed or responded to per, for example, learning material (e.g., an online textbook) assigned to the user by an instructor. Alternatively, the questions may be generated based on one or more constraints, as discussed further herein with reference to FIG. 13.

According to the method 1000, the learning tool server 120 or 200 or the student user device 130 or 300 (depending on which device performs this operation) selects a (or another) question from the set of one or more questions (block 1008). Then, the student user device displays a screen on the user interface (display) 340, wherein the screen includes the selected question with an input object for receiving a response to the question (block 1010). The screen may also include an indication of the difficulty level of the selected question. Examples of such a screen are depicted in FIGS. 12A-12C. Further, according to the method 1000, the student user device receives a response to the selected question from the user via the input object (block 1012).

According to the method 1000, the learning tool server 120 or 200 or the student user device 130 or 300 (depending on which device performs this operation) determines whether the response from the user is correct (block 1014). If the learning tool server is the device that performs this operation, the student user device communicates the response to the learning tools server. If it is determined that the response is incorrect, then the student user device displays a screen on the user interface (display) 340 indicating at least that the response is incorrect (block 1016). On the other hand, if it is determined that the response is correct, then the student user device displays a screen on the user interface (display) 340 indicating at least that the response is correct (block 1018).

According to the method 1000, the learning tool server 120 or 200 or the student user device 130 or 300 (depending on which device performs this operation) determines whether there is a least one more question remaining in the generated set of questions (block 1020). If there is at least one more question remaining, the learning tool server or the student user device (depending on which device performs this operation) proceeds back to block 1008 to select another question and the method 1000 continues therefrom as previously discussed. If, on the other hand, there is no more question remaining in the set, the student user device displays a screen indicating that the learning activity is complete (block 1022).

FIG. 11 illustrates a screen 1100 of an exemplary quiz generator in accordance with another aspect of the disclosure. As illustrated, the screen 1100 includes various input objects for receiving parameters from a user for controlling the generation of a quiz. In this example, the screen 1100 includes an input object in the form of a textbox (represented by a dashed box) for entering the number of questions for the quiz to be generated. Also, the screen 1100 includes another input object in the form of a drop down menu for selecting a topic among a list of topics. Additionally, the screen 1100 another input object in the form of a selection options (e.g., 1 2 3 4 5) for entering the difficulty level for the questions of the quiz to be generated. Further, the screen includes a submit button for submitting the various parameters (number of questions, selected topic, and selected difficulty level) for controlling the generation of the quiz.

It shall be understood that the quiz generator may generate a set of questions based on a different set of parameters others than exemplified in screen 1100. Further, it shall be understood that the input objects for receiving parameters from a user may be configured in a different style as those included in the screen 1100.

FIGS. 12A-1 to 12A-3 illustrate a first set of screens 1210, 1220, and 1230 of exemplary questions pertaining to a first difficulty level of a learning activity in accordance with another aspect of the disclosure. As illustrated, each of the screens 1210, 1220, and 1230 includes the question presented (e.g., the question for screen 1210 is Y=6×5, Y is?). Additionally, each of the screens 1210, 1220, and 1230 includes an indicator (DL) of the difficulty level of the corresponding question (e.g., the difficulty level (DL) for the questions of screens 1210, 1220, and 1230 is 1 (DL=1). Each of the screens 1210, 1220, and 1230 includes an input object for receiving a response to the corresponding question and a submit button for sending the response to the processor 310 of the student user device 130 or 300.

The questions indicated in the screens 1210, 1220, and 1230 are examples of questions that may be stored in a database, and for which the learning tool server 120 or 300 or the student user device may select in response to a user selecting difficulty level 1 per block 1006 of method 1000 using, for example, screen 1100. In this example, the questions assigned to difficulty level 1 are questions involving the multiplication of a single digit number (e.g., 6 in screen 1210) with another single digit number (e.g., 5 in screen 1210).

FIGS. 12B-1 to 12B-3 illustrate a second set of screens 1240, 1250, and 1260 of exemplary questions related to a second difficulty level of a learning activity in accordance with another aspect of the disclosure. Each of the screens 1240, 1250, and 1260 may be configured similar to each of the screens 1210, 1220, and 1230, previously discussed. A difference between the screens 1240, 1250, and 1260 and screens 1210, 1220, and 1230 is that the questions indicated in screens 1240, 1250, and 1260 have a (second) difficulty level greater than the (first) difficulty level of the questions indicated in screens 1210, 1220, and 1230.

The questions indicated in the screens 1240, 1250, and 1260 are examples of questions that may be stored in a database, and for which the learning tool server 120 or 200 or the student user device 130 or 300 may select in response to a user selecting difficulty level 2 per block 1006 of method 1000 using, for example, screen 1100. In this example, the questions assigned to difficulty level 2 are questions involving the multiplication of a single digit number (e.g., 4 in screen 1240) with a double digit number (e.g., 23 in screen 1240).

FIGS. 12C-1 to 12C-3 illustrate a third set of screens 1270, 1280, and 1290 of exemplary questions related to a second difficulty level of a learning in accordance with another aspect of the disclosure. Each of the screens 1270, 1280, and 1290 may be configured similar to each of the screens 1210, 1220, 1230, 1240, 1250, and 1260 previously discussed. A difference between the screens 1270, 1280, and 1290 and screens 1240, 1250, and 1260 is that the questions indicated in screens 1270, 1280, and 1290 have a (third) difficulty level greater than the (second) difficulty level of the questions indicated in screens 1240, 1250, and 1260.

The questions indicated in the screens 1270, 1280, and 1290 are examples of questions that may be stored in a database, and for which the learning tool server 120 or 200 or the student user device 130 or 300 may select in response to a user selecting difficulty level 3 per block 1006 of method 1000 using, for example, screen 1100. In this example, the questions assigned to difficulty level 3 are questions involving the multiplication of two double-digit numbers (e.g., 42 and 71 in screen 1270).

FIG. 13 illustrates a flow diagram of an exemplary method 1300 of generating questions based on first, second, and third sets of constraints related respectively to first, second, and third difficulty levels of a learning activity in accordance with another aspect of the disclosure. The method 1300 may be an exemplary more detailed implementation of generating a question per block 1006 of the method 1000.

According to the method 1300, the learning tool server 120 or 200 or the student user device 130 or 300 (depending on which device performs this operation) determines the selected difficulty level by the user (block 1302). If it is determined that the selected difficulty level is DL=1 in block 1304, the learning tool server or student user device generates a question based on a first set of one or more constraints, a correct answer for the question, and an explanation of the correct answer (block 1306).

As an example, the first set of one or more constraints may include: Constraint 1: indicating a multiplication exercise with a format Y=a×b, where a and b are constants and × is the multiplication operator; Constraint 2: where the constants a and b are each a single-digit number; Constraint 3: where a and b are generated (e.g., randomly generated); Constraint 4: where the correct answer Y is determined based on the generated constants a and b; and Constraint 5: where an explanation of the correct answer is provided. Based on these constraints, a question such as those depicted in screens of FIGS. 12A-1 to 12A-3 may be generated. If the learning tool server 120 or 200 is the device that generates the question, the learning tool server then sends the generated question to the student user device 130 or 300 for displaying per block 1010 of the method 1000. Once the question is generated, the method 1300 is done until reinitialized per another execution of block 1006.

If it is determined that the selected difficulty level is DL=2 in block 1304, the learning tool server or student user device generates a question based on a second set of one or more constraints, a correct answer for the question, and an explanation of the correct answer (block 1308).

As an example, the second set of one or more constraints may include: Constraint 1: indicating a multiplication exercise with a format Y=a×b, where a and b are constants and × is the multiplication operator; Constraint 2: where the constant a is a single-digit number and the constant b is a double-digit number; Constraint 3: where a and b are generated (e.g., randomly generated); Constraint 4: where the correct answer Y is determined based on the generated constants a and b; and Constraint 5: where an explanation of the correct answer is provided. Based on these constraints, a question such as those depicted in screens of FIGS. 12B-1 to 12B-3 may be generated. If the learning tool server 120 or 200 is the device that generates the question, the learning tool server then sends the generated question to the student user device 130 or 300 for displaying per block 1010 of the method 1000. Once the question is generated, the method 1300 is done until reinitialized per another execution of block 1006.

If it is determined that the selected difficulty level is DL=3 in block 1304, the learning tool server or student user device generates a question based on a third set of one or more constraints, a correct answer for the question, and an explanation of the correct answer (block 1310).

As an example, the third set of one or more constraints may include: Constraint 1: indicating a multiplication exercise with a format Y=a×b, where a and b are constants and × is the multiplication operator; Constraint 2: where the constants a and b are both double-digit numbers; Constraint 3: where a and b are generated (e.g., randomly generated); Constraint 4: where the correct answer Y is determined based on the generated constants a and b; and Constraint 5: where an explanation of the correct answer is provided. Based on these constraints, a question such as those depicted in screens of FIGS. 12C1-12C3 may be generated. If the learning tool server 120 or 200 is the device that generates the question, the learning tool server then sends the generated question to the student user device 130 or 300 for displaying per block 1010 of the method 1000. Once the question is generated, the method 1300 is done until reinitialized per another execution of block 1006.

### Exercise or Quiz Generator Based on User Progress Metric

In summary, a system is provided where topics can be learned by a user. The system provides: means for generating a quiz including questions to which a user submits answers (responses), and receiving a score based on correctness of the submitted answers. The system also provides for generating a quiz including a set of questions based on a metric indicative of the performance of a user in learning one or more topics associated with the generated quiz.

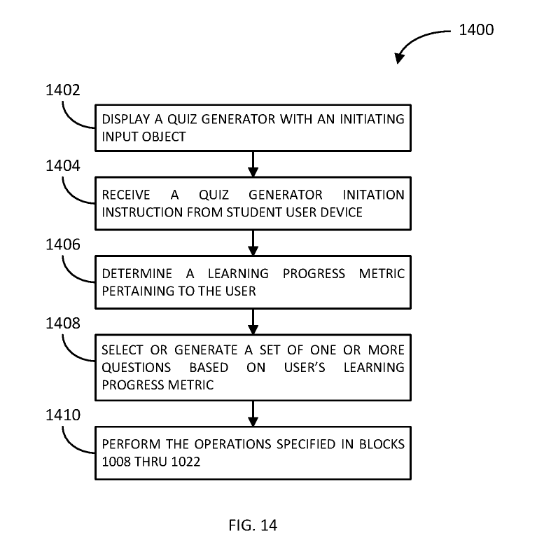

FIG. 14 illustrates a flow diagram of another exemplary method 1400 of generating a learning activity (e.g., a quiz) based on a learning progress metric of a user in accordance with another aspect of the disclosure. The method 1400 is similar to that of method 1000, except that instead of the set of one or more questions being generated based on one or more inputs received from a user, the set of one or more questions are generated based on a learning progress metric associated with the user.

According to the method 1400, the student user device 130 or 300 displays a screen including a quiz generator with an input object for a user to initiate the generation of a quiz (block 1402). Then, the student user device receives the initiation instruction from the user via the input object (block 1404).

Then, according to the method 1400, the learning tool server 120 or 200 or the student user device 130 or 300 (depending on which device performs this operation) determines a learning progress metric pertaining to the user (block 1406). The learning progress metric may be a measure of how successfully the user has previously responded to questions of prior completed learning activities or grades received in an actual or virtual (online) classroom. Such learning progress metric (or information from which the learning progress metric may be derived) may be associated with a student data object stored in the memory 220 accessible by the learning tool server 120 or 200.

Then, according to the method 1400, the learning tool server 120 or 200 or the student user device 130 or 300 (depending on which device performs this operation) selects or generates a set of one or more questions based on the user's learning progress metric (block 1408). For example, based on the learning progress metric, the learning tool server or student user device may select the number of the questions in the quiz, the topic associated with the questions, and difficulty level of the questions. For example, the learning tool server or student user device may select questions similar to those indicated in screens 1240, 1250, and 1260, previously discussed. Then, according to the method 1400, the operations specified in blocks 1008 through 1022 may be performed as previously discussed.

Thus, the concept here is that the user-student may desire to generate and take a quiz for self-assessment and/or other purposes, where the questions presented to the user-student pursuant to the quiz is based on the known strength of the user-student with regard to the subject matter of the questions being presented.

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A user device, comprising:
a user interface; and
a processor configured to:
instruct the user interface to display a first screen including a first question assigned to a first step of a learning activity, wherein the first screen includes a first input object configured to receive a first response to the first question from a user; and
instruct the user interface to display a second screen including a second question assigned to the first step of the learning activity in response to an incorrect response received via the first input object; or
instruct the user interface to display a third screen including an indication that the learning activity has been completed by the user in response to a correct response received via the first input object and no other step of the learning activity is required to be completed by the user to complete the learning activity; or
instruct the user interface to display a fourth screen including a third question assigned to a second step of the learning activity in response to a correct response received via the first input object and the second step is required to be completed by the user to complete the learning activity.

2. The user device of claim 1, wherein at least one of the first question or the second question is selected from a set of questions assigned to the first step.

3. The user device of claim 1, wherein at least one of the first question or the second question is generated based on a set of one or more constraints assigned to the first step.

4. The user device of claim 1, wherein the third question is selected from a set of questions assigned to the second step.

5. The user device of claim 1, wherein the third question is generated based on a set of one or more constraints assigned to the second learning step.

6. The user device of claim 1, wherein the processor is configured to instruct the user interface to display a fifth screen including a learning progress indicator indicative of the number of one or more steps including the first step of the learning activity completed by the user.

7. The user device of claim 1, wherein the processor is configured to instruct the user interface to display a fifth screen including a learning progress indicator comprising a visual indicator indicating which of the one or more steps have been completed by the user.

8. The user device of claim 1, wherein a learning progress indicator pertaining to the user is maintained unadjusted in response to the correct response to the first question being received via the first input object, and the user has previously correctly responded to a fourth question assigned to the first step.

9. The user device of claim 1, wherein the processor is configured to instruct the user interface to display a fifth screen indicating that the response to the first question is incorrect in response to the incorrect response received via the first input object.

10. The user device of claim 1, wherein the processor is configured to instruct the user interface to display a fifth screen indicating a correct answer to the first question in response to the incorrect response received via the first input object.

11. The user device of claim 1, wherein the processor is configured to instruct the user interface to display a fifth screen indicating that the response to the first question is correct in response to the correct response received via the first input object.

12. The user device of claim 1, wherein the processor is configured to instruct the user interface to display a fifth screen including an explanation of a correct answer to the first question.

13. The user device of claim 1, wherein the processor is configured to instruct the user interface to display a fifth screen including an indication of a wrong portion of the incorrect response received from the user via the input object.

14. The user device of claim 1, wherein the processor is configured to instruct the user interface to display a fifth screen including an indication of a difference between a correct answer and the incorrect response received from the user via the input object.

15. The user device of claim 1, wherein a difficulty of the third question is greater than a difficulty of the first question or the second question.

16. The user device of claim 1, wherein the learning activity includes one or more steps for completion by the user prior to the first step, wherein the one or more steps are not required to be completed by the user to complete the learning activity.

17. The user device of claim 16, wherein the one or more steps are not required to be completed by the user based on a learning progress metric pertaining to the user.

18. The user device of claim 16, wherein the one or more steps are not required to be completed by the user based on the processor receiving an instruction from a second user device via a network interface.

19. The user device of claim 1, wherein the first step of the learning activity is selected by the user.

20. A user device, comprising:
a user interface; and
a processor configured to:
instruct the user interface to display a first screen including a question of a learning activity, wherein the first screen includes an input object configured to receive a response to the question from a user; and
instruct the user interface to display a second screen including one or more identifiers to one or more topics recommended for reviewing by the user based on the response to the question received from the user via the input object.

21. The user device of claim 20, wherein the response to the question is incorrect.

22. The user device of claim 20, wherein the one or more topic identifiers comprise one or more hyperlinks to content pertaining to the one or more topics, respectively.

23. The user device of claim 22, wherein the processor is configured to instruct the user interface to display one or more screens including the content pertaining to the one or more topics in response to an activation of the one or more hyperlinks by the user, respectively.

24. The user device of claim 23, wherein the processor is configured to instruct the user interface to generate a third screen including one or more indications of completion of reviewing the one or more topics in response to an activation of one or more return hyperlinks in the one or more topic content screens, respectively.

25. The user device of claim 20, wherein the second screen includes one or more visual indicators to indicate a relative importance of the one or more topics, respectively.

26. The user device of claim 25, wherein the one or more visual indicators include at least one of: one or more values associated with the one or more topic identifiers, relative sizes of the one or more topic identifiers, distinct colors associated with the one or more topic identifiers, or order in which the one or more topics are listed, respectively.

27. The user device of claim 20, wherein the processor is configured to instruct the user interface to display learning content associated with the one or more topics prior to the user interface displaying the first screen.

28. The user device of claim 20, wherein the processor is configured to instruct the user interface to display learning content associated with the one or more topics after the user interface displays the first screen.

29. A user device, comprising:
a user interface; and
a processor configured to:
instruct the user interface to display a set of screens including a set of questions of a learning activity, wherein the set of screens include a set of input objects configured to receive a set of responses to the set of questions from a user, respectively; and
instruct the user interface to display another screen including one or more identifiers to one or more topics recommended for reviewing by the user based on at least some of the responses of the set.

30. The user device of claim 29, wherein the another screen indicates a completion of the learning activity.

31. The user device of claim 29, wherein the at least some of the responses consists of only one or more incorrect responses to one or more questions of the set.

32. The user device of claim 29, wherein the one or more topic identifiers comprise one or more hyperlinks to content pertaining to the one or more topics, respectively.

33. The user device of claim 29, wherein the another screen includes one or more visual indicators to indicate a relative importance of the one or more topics, respectively.

34. A user device, comprising:
a user interface; and
a processor configured to:
instruct the user interface to display a first screen including one or more input objects to receive one or more parameters from a user, the one or more parameters controlling a selection or generation of a set of questions; and
instruct the user interface to display a set of screens including the set of questions selected or generated based on the one or more parameters, respectively, wherein the set of screens include a set of input objects to receive responses to the set of questions from the user, respectively.

35. The user device of claim 34, wherein the one or more parameters include a number of questions in the set of questions.

36. The user device of claim 34, wherein the one or more parameters include a topic to which the set of questions are related.

37. The user device of claim 34, wherein the one or more parameters include a difficulty level of the set of questions.

38. The user device of claim 34, wherein the set of screens include a set of difficulty level indicators related to the set of questions, respectively.

39. The user device of claim 34, wherein the set of questions are selected from a database of questions based on the one or more parameters.

40. The user device of claim 34, wherein the set of questions are generated based on one or more constrains that are, in turn, based on the one or more parameters.

41. The user device of claim 34, wherein the processor is configured to instruct the user interface to display at least one screen indicating one or more topics recommended to be reviewed by the user in response to receiving at least one incorrect response to the set of questions from the user via at least a corresponding one of the set of input objects, respectively.

42. The user device of claim 41, wherein the one or more topic indicators comprise one or more hyperlinks to content pertaining to the one or more topics, respectively.

43. The user device of claim 41, wherein the processor is configured to instruct the user interface to display learning content based on the set of responses to the set of questions, respectively.

44. The user device of claim 41, wherein the selection of the set of questions is from questions previously displayed to the user.

45. The user device of claim 41, wherein the processor is configured to instruct the user interface to display learning content associated with the one or more topics after the user interface displays the set of screens.

46. A user device, comprising:
a user interface; and
a processor configured to instruct the user interface to display a set of screens including the set of questions based on a learning progress metric associated with a user, wherein the set of screens includes a set of input objects to receive responses to the set of questions from the user, respectively.
